(19) United States
(12) Patent Application Publication
(10) Pub. No.: US 2026/0342727 A1
(43) Pub. Date: Oct. 29, 2026

(54) CONFIGURABLE IN-VEHICLE NETWORK SUPPLY METHOD, APPARATUS AND SYSTEM, AND VEHICLE

(71) Applicant: Chongqing Changan Technology Co., Ltd., Chongqing (CN)

(72) Inventors: Qiang WANG, Chongqing (CN); Jiang YU, Chongqing (CN)

(73) Assignee: Chongqing Changan Technology Co., Ltd., Chongqing (CN)

(21) Appl. No.: 19/705,814

(22) Filed: Jun. 12, 2026

Related U.S. Application Data
(63) Continuation of application No. PCT/CN2024/112187, filed on Aug. 14, 2024.

(30) Foreign Application Priority Data
Feb. 1, 2024 (CN) 202410150647.6

(51) Int. Cl. H04L 45/745; H04L 61/4511

(52) U.S. Cl. CPC H04L 45/745; H04L 61/4511

(57) ABSTRACT

The present application relates to the field of in-vehicle network communication technologies, and specifically discloses a configurable in-vehicle network supply method, an apparatus and a system, and a vehicle. The method includes: acquiring multiple pre-configured management tables and a network camping state, where the multiple management tables include: a dialing address management table and a domain name forwarding management table; starting a dialing program, and performing multilink dialing according to the dialing address management table and the network camping state; and generating a routing table and a domain name system DNS mapping table according to the domain name forwarding management table and the multilink dialing, where the DNS mapping table includes a mapping relationship between a target domain name and an IP address, and the routing table includes a correspondence between the target domain name and a dialing channel.

### CROSS-REFERENCE TO RELATED APPLICATIONS

This application is a continuation of International PCT Application No. PCT/CN2024/112187, filed on Aug. 14, 2024, which claims priority to Chinese patent application No. 202410150647.6, filed to China National Intellectual Property Administration on Feb. 1, 2024, and entitled “CONFIGURABLE IN-VEHICLE NETWORK SUPPLY METHOD, APPARATUS AND SYSTEM, AND VEHICLE”. The disclosures of the aforementioned applications are hereby incorporated by reference in their entireties.

### TECHNICAL FIELD

The present application relates to the field of in-vehicle network communication technologies and, in particular, to a configurable in-vehicle network supply method, an apparatus and a system, and a vehicle.

### BACKGROUND

Traditional in-vehicle dial-up internet access devices generally can only distinguish and configure different dialing channels through ports or local area networks, and cannot meet the internet access billing requirements of multiple devices in multiple VLANs (Virtual Local Area Networks) according to different services. For example, an in-vehicle entertainment system cannot distinguish between manufacturer OTA (Over The Air Technology) upgrade traffic and user entertainment traffic on a terminal.

### SUMMARY

In view of this, the present application provides a configurable in-vehicle network supply method, an apparatus and a system, and a vehicle, so as to solve the problem of difficulty in billing traffic for different server services. To solve this technical problem, the following technical solutions are disclosed in the embodiments of the present disclosure.

In a first aspect, the present application discloses a configurable in-vehicle network supply method, and the method includes:
acquiring multiple pre-configured management tables and a network camping state, where the multiple management tables include: a dialing address management table and a domain name forwarding management table, the dialing address management table is used to configure addresses, user names, and default dialing channels of multilink dialing corresponding to each operator in an in-vehicle network supply system, and the domain name forwarding management table is used to configure a relationship between each service target domain name using a non-default channel and a dialing channel;
starting a dialing program, and performing multilink dialing according to the dialing address management table and the network camping state;
generating a routing table and a domain name system DNS mapping table according to the domain name forwarding management table and the multilink dialing, where the DNS mapping table includes a mapping relationship between a target domain name and an IP address, and the routing table includes a correspondence between the target domain name and the dialing channel.

In combination with the first aspect, in an implementation, the multiple management tables further include a virtual local area network configuration management table, and the virtual local area network configuration management table is used to configure a relationship between an Ethernet and the dialing channel.

Generating the routing table and the DNS mapping table according to the domain name forwarding management table and the multilink dialing includes: generating the routing table and the DNS mapping table according to the domain name forwarding management table, the virtual local area network configuration management table, and the multilink dialing.

In combination with the first aspect, in another implementation, performing the multilink dialing according to the dialing address management table and the network camping state includes: acquiring a SIM card number, and determining an operator name to which a current SIM card belongs according to the SIM card number; searching for a matching dialing address in the dialing address management table according to the operator name, and clearing an existing data channel cache; performing the multilink dialing according to a found dialing address.

In combination with the first aspect, in yet another implementation, after performing the multilink dialing according to the found dialing address, the method further includes: acquiring at least one public network IP address and a DNS address fed back by different operators after the multilink dialing; and binding the at least one public network IP address and the DNS address with a local egress network card to obtain a correspondence among the local egress network card, the public network IP address, and the DNS address.

In combination with the first aspect, in yet another implementation, before acquiring the SIM card number, the method further includes: acquiring a state of the SIM card, and checking whether a SIM card state is normal; if the state is confirmed to be normal, performing the step of acquiring the SIM card number.

In combination with the first aspect, in yet another implementation, generating the routing table according to the domain name forwarding management table and the multilink dialing includes: determining, according to the DNS address acquired from the multilink dialing, in the domain name forwarding management table, the dialing channel corresponding to the target domain name; querying correctness of the target domain name, and acquiring the IP address corresponding to the target domain name; establishing a correspondence between the DNS address and the IP address corresponding to the target domain name, and storing the correspondence in a DNS service cache.

In combination with the first aspect, in yet another implementation, after generating the routing table and the DNS mapping table, the method further includes: during a system network access process, acquiring a first domain name requested to be accessed by a target device; searching in the DNS service cache for whether a matching dialing channel exists according to the first domain name;
if exists, acquiring a first dialing channel with a pre-established matching relationship, and performing dial-up network access through the first dialing channel;
if not exists, resolving the DNS address according to a default dialing channel to obtain a second dialing channel having an associated relationship with the first domain name, and performing dial-up network access through the second dialing channel.

In combination with the first aspect, in yet another implementation, the method further includes: starting a network protection program, and confirming at least one dialing channel requiring periodic detection according to the dialing address management table; performing ping connectivity detection on the at least one dialing channel to determine whether each dialing channel is unobstructed; acquiring and recording a detection result, and notifying the detection result to a dialing system process.

In combination with the first aspect, in yet another implementation, acquiring and recording the detection result, and notifying the detection result to the dialing system process includes: notifying the dialing system process of a detection result that a dialing channel is disconnected, where the detection result includes a dialing channel ID of a disconnected dialing channel, and the detection result is used to indicate disconnecting a connection of the dialing channel ID.

In combination with the first aspect, in yet another implementation, the method further includes: when the dialing program receives a state change of a network detection from disconnected to connected by a network camping monitoring program, redialing to perform the multilink dialing according to the dialing address management table and the network camping state, and updating the routing table and the DNS mapping table.

In a second aspect, the present application provides a configurable in-vehicle network supply apparatus, and the apparatus includes:
an acquisition module, configured to acquire multiple pre-configured management tables and a network camping state, where the multiple management tables include: a dialing address management table and a domain name forwarding management table, the dialing address management table is used to configure addresses, user names, and default dialing channels of multilink dialing corresponding to each operator in an in-vehicle network supply system, and the domain name forwarding management table is used to configure a relationship between a service target domain name using a non-default channel and a dialing channel;
a dialing module, configured to start a dialing program, and perform multilink dialing according to the dialing address management table and the network camping state;
a generation module, configured to generate a routing table and a domain name system DNS mapping table according to the domain name forwarding management table and the multilink dialing, where the DNS mapping table includes a mapping relationship between a target domain name and an IP address, and the routing table includes a correspondence between the target domain name and the dialing channel.

In a third aspect, the present application further provides a configurable in-vehicle network supply system, where the system includes: at least one electronic control unit ECU, a communication module, and at least one service server, and the at least one ECU is connected to the at least one service server through the communication module;
each ECU is configured to execute the configurable in-vehicle network supply method according to the first aspect or any implementation of the first aspect;
the communication module is configured to communicate with the at least one service server according to an instruction sent by the ECU;
each service server is configured to provide a dial-up network access service for the ECU.

In a fourth aspect, the present application further provides a vehicle, where the vehicle includes a configurable in-vehicle network supply system according to the third aspect or any implementation of the third aspect.

In a fifth aspect, the present application provides an electronic device, including: a memory and a processor, where the memory is communicatively connected to the processor, the memory stores computer instructions, and the processor performs the configurable in-vehicle network supply method according to the first aspect or any corresponding implementation thereof by executing the computer instructions.

In a sixth aspect, the present application provides a program product, including: a computer program, where when the program product is run on a computer, the computer is caused to execute the configurable in-vehicle network supply method according to the first aspect or any corresponding implementation thereof.

In a seventh aspect, the present application provides a computer program, where when executed by a processor, the computer program is used to execute the configurable in-vehicle network supply method according to the first aspect or any corresponding implementation thereof.

Furthermore, the present application provides a computer-readable storage medium, where the computer-readable storage medium stores computer instructions, and the computer instructions are used to cause a computer to execute the configurable in-vehicle network supply method according to the first aspect or any corresponding implementation thereof.

According to the configurable in-vehicle network supply method, the apparatus and the system, and the vehicle provided by the present application, by pre-configuring the multiple management tables, such as the dialing address management table and the domain name forwarding management table, after starting the dialing program, the multilink dialing can be performed according to the dialing address management table and the network camping state, and the routing table and the domain name system DNS mapping table are generated. Since the DNS mapping table includes the mapping relationship between the target domain name and the IP address, and the routing table includes the correspondence between the target domain name and the dialing channel, the method completes the network supply strategy arrangement for various controllers of the whole vehicle, supports services such as multilink dialing, multilink VLAN, multi-device network supply, and data distribution according to the target domain name.

The method, apparatus, and system provided by the present application allows vehicle manufacturers to be compatible with different operators according to requirements, configure multiple network access channels and Ethernet network supply strategies, and separate different network access channels according to device network access services, thereby ensuring the independence and chargeability of each data channel, avoiding mutual interference, and simultaneously adding the network protection strategy to ensure network reliability.

### BRIEF DESCRIPTION OF THE DRAWINGS

In order to illustrate the technical solutions in the embodiments of the present application or in the prior art more clearly, the accompanying drawings required for the description of the embodiments or the prior art will be briefly introduced below. Obviously, the drawings in the following description are some embodiments of the present application, and for those of ordinary skill in the art, other drawings may be obtained based on these drawings without creative effort.

FIG. 1 is a schematic diagram of a scenario of a configurable in-vehicle network supply system provided by an embodiment of the present application.

FIG. 2 is a schematic flowchart of a configurable in-vehicle network supply method provided by an embodiment of the present application.

FIG. 3 is a structural block diagram of an in-vehicle networking system provided by an embodiment of the present application.

FIG. 4 is a schematic flowchart of another configurable in-vehicle network supply method provided by an embodiment of the present application.

FIG. 5 is a schematic flowchart of a multilink dialing method provided by an embodiment of the present application.

FIG. 6 is a flowchart of ping connectivity detection provided by an embodiment of the present application.

FIG. 7 is an architecture diagram for generating a routing table and a DNS mapping table provided by an embodiment of the present application.

FIG. 8 is a structural block diagram of a configurable in-vehicle network supply apparatus provided by an embodiment of the present application.

FIG. 9 is a structural block diagram of a vehicle provided by an embodiment of the present application.

FIG. 10 is a schematic structural diagram of an electronic device provided by an embodiment of the present application.

### DESCRIPTION OF EMBODIMENTS

In order to make the objectives, technical solutions, and advantages of the embodiments of the present application more clear, the technical solutions in the embodiments of the present application will be described clearly and completely below in conjunction with the drawings in the embodiments of the present application. Obviously, the described embodiments are a part rather than all of the embodiments of the present application. Based on the embodiments in the present application, all other embodiments obtained by those skilled in the art without creative effort fall within the protection scope of the present application.

The technical solutions provided by the embodiments of the present application are applied to the Internet of things or the Internet of vehicles, and specifically, can be applied to a configurable in-vehicle network supply system. The in-vehicle network supply system is configured to enable vehicle manufacturers to be compatible with different operators according to requirements, configure multiple network access channels and Ethernet network supply strategies, and separate different network access channels according to device network access services, thereby ensuring the independence and chargeability of each data channel, avoiding mutual interference, and simultaneously adding the network protection strategy to ensure network reliability.

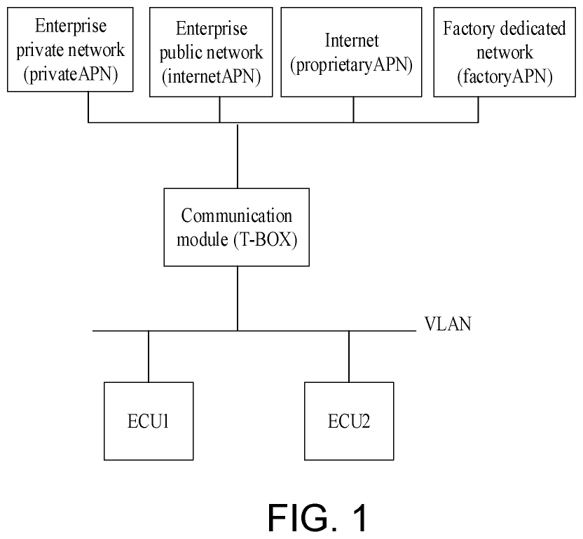

Referring to FIG. 1, a schematic diagram of a scenario of a configurable in-vehicle network supply system provided by an embodiment of the present application is shown. The system includes: at least one ECU (Electronic Control Unit), a communication module, and at least one service server. The at least one ECU is connected to the at least one service server via the communication module. For example, ECU1 is connected to an enterprise private network (privateAPN) server via a communication module TBOX. Similarly, ECU2, ECU3, etc. are also connected to other servers, such as an enterprise public network (internetAPN), the Internet (proprietary APN), and a factory dedicated network (factoryAPN), via the TBOX module.

In addition, the TBOX is connected to ECU1 and ECU2 via an Ethernet, such as a VLAN.

TBOX refers to a roof box (Telematics Box), which is an apparatus installed in a vehicle for collecting and transmitting vehicle-related data, including vehicle speed, mileage, driving behavior, and other information.

ECU, also known as a “driving computer” of a vehicle, is used to control a driving state of the vehicle and realize its various functions. It mainly uses data collection and exchange of various sensors and buses to determine a vehicle state and driver intentions, and control the vehicle through actuators.

The above-mentioned cloud servers, such as the enterprise private network, the enterprise public network, the Internet, and the factory dedicated network, can all be implemented by cloud network devices.

In a process of in-vehicle network supply convergence, each ECU distinguishes different dialing channels through ports or local area networks (such as VLAN), and performs billing according to different services. For example, the vehicle system over the air technology (OTA) refers to an in-vehicle online remote upgrade OTA function, meaning a vehicle system software upgrade, that is, a function that a vehicle owner can upgrade remotely online. Such type of function is very common in cars and motorcycles and is a necessary function for vehicle models with smart in-vehicle central control system.

However, for current in-vehicle entertainment systems, it is impossible to distinguish between manufacturer OTA upgrade traffic and user entertainment traffic on a terminal, thus causing difficulty in separate billing. To solve this technical problem, in the embodiments of the present disclosure, a configurable in-vehicle network supply method is provided, which can be applied to the above-mentioned vehicles or in-vehicle network supply systems.

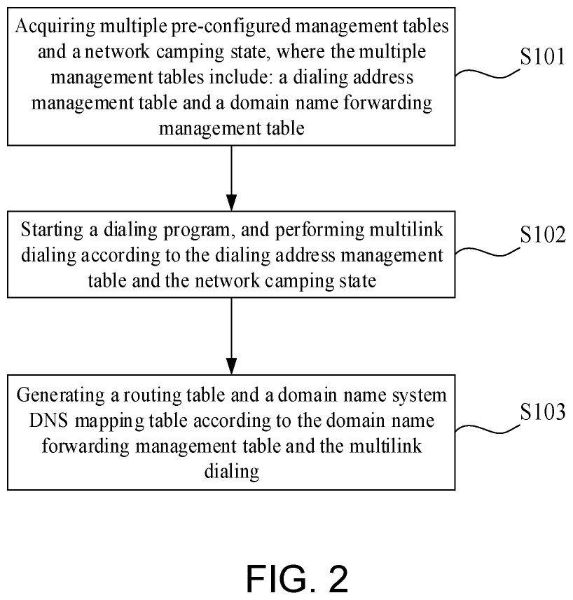

FIG. 2 is a flowchart of a configurable in-vehicle network supply method according to an embodiment of the present application. The flowchart may be executed by any one of the above-mentioned ECU1 and ECU2, and the method specifically includes the following steps.

Step S101, acquiring multiple pre-configured management tables and a network camping state, where the multiple management tables include: a dialing address management table and a domain name forwarding management table.

The dialing address management table is used to configure addresses, user names, and default dialing channels of multilink dialing corresponding to each operator in an in-vehicle network supply system, and the domain name forwarding management table is used to configure a relationship between a service target domain name using a non-default channel and a dialing channel.

Specifically, the dialing address management table includes the addresses, the user names, and configured default data dialing channels of the multilink dialing corresponding to each operator. As shown in Table 1 below.

TABLE 1
Dialing Address Management Table

| | | | Dialing Channel |
|---|---|---|---|
| APN Type | APN Name | APN Address | datacall |
| privateAPN | apnName | cq01.5gsc.cdiot | datacall = 1 |
| internetAPN | apnName | cq02.5gsc.cdiot | datacall = 2 |
| proprietaryAPN | apnName | cq03.5gsc.cdiot | datacall = 3 |
| factoryAPN | apnName | YYYY | datacall = 4 |
| default_router | — | — | datacall = 3 |

In an implementation, the dialing address management table further includes passwords, keys, etc., which are not shown in Table 1.

In addition, it is used to configure a relationship between each service target domain name that needs to be transmitted over a non-default channel and dialing, and includes physical network cards, network bridges, dialing IDs, and lists of domain names that need to be transmitted over corresponding dialing channels. As shown in Table 2.

TABLE 2
Domain Name Forwarding Management Table

| | Network | Dialing | |
|---|---|---|---|
| Gateway | Bridge | channel | Domain Name |
| eth0 | bridge11 | 1 | uds.******com.cn, |
| | | | tusys.******.com.cn, |
| | | | vcmq.******.com. |
| eth0 | bridge11 | 2 | huapp.******.com.cn, |
| | | | damq.******.com.cn, |
| | | | infomq.******.com.cn. |
| eth0 | bridge11 | 2 | fc.******.com.cn, |
| | | | cdnsrc.******.com.cn, |
| | | | cdn.sd.******.com.cn. |
| eth0 | bridge11 | 2 | uds.******.com.cn, |
| | | | tusys.******.com.cn. |
| eth0 | bridge11 | 4 | factory.******.com.cn. |

Step S102, starting a dialing program, and performing multilink dialing according to the dialing address management table and the network camping state.

Specifically, step S102 includes: first, acquiring a SIM card number, and determining an operator name to which a current SIM card belongs according to the SIM card number; then, searching for a matching dialing address in the dialing address management table according to the operator name, and clearing an existing data channel cache; finally, performing the multilink dialing according to a found dialing address.

Further, after performing the multilink dialing according to the found dialing address, the method further includes: acquiring at least one public network IP address and a DNS address fed back by different operators after the multilink dialing; and binding the at least one public network IP address and the DNS address with a local egress network card to obtain a correspondence among the local egress network card, the public network IP address, and the DNS address.

This correspondence may be used for subsequent searching for a destination IP address.

Step S103, generating a routing table and a domain name system DNS mapping table according to the domain name forwarding management table and the multilink dialing.

The DNS mapping table includes a mapping relationship between a target domain name and an IP address, and the routing table includes a correspondence between the target domain name and the dialing channel.

In an implementation, the routing table may also be referred to as a “TBOX routing table”, used to represent a correspondence among the target domain name, the IP addresses, and a default route. For example, a DNS route of APN1 is determined after dialing apn1.

The DNS mapping table includes the target domain names, such as a correspondence among a DNS, a gateway, and the IP address.

In the configurable in-vehicle network supply method provided by the present application, by pre-configuring the multiple management tables, such as the dialing address management table and the domain name forwarding management table, after starting the dialing program, the multilink dialing can be performed according to the dialing address management table and the network camping state, and the routing table and the domain name system DNS mapping table are generated. Since the DNS mapping table includes the mapping relationship between the target domain name and the IP address, and the routing table includes the correspondence between the target domain names and the dialing channel, this method completes the network supply strategy arrangement for various controllers of the whole vehicle, supports services such as multilink dialing, multilink VLAN, and multi-device network supply, and data distribution according to the target domain name.

Before the above step S101, the multiple management tables further include a virtual local area network configuration management table, and the virtual local area network configuration management table is used to configure a relationship between an Ethernet and the dialing channel.

In an implementation, the virtual local area network configuration management table is a VLAN configuration management table. The VLAN configuration management table is used to configure the association relationship between the Ethernet and dialing, including VLAN IDs, original network cards, network bridges, network segments, local addresses, MAC addresses, and corresponding dialing IDs. For example, as shown in Table 3.

TABLE 3
VLAN Configuration Management Table

| | Original | | | | | |
|---|---|---|---|---|---|---|
| VLAN | Network | Network | Network | Local | MAC | Dialing |
| ID | Card | Bridge | Segment | Address | Address | channel |
| 6 | eth0 | bridge6 | 172.29.6.0/ | 172.29.6.54 | AB:AB:AB:23:03:04 | −1 |
| | | | 24 | | | |
| 11 | eth0 | bridge11 | 172.29.11.0/ | 172.29.11.54 | 00:02:03:04:05:06 | 3 |
| | | | 24 | | | |
| 12 | eth0 | bridge12 | 172.29.12.0/ | 172.29.12.54 | 00:02:03:04:05:07 | 4 |
| | | | 24 | | | |

The above step S103 specifically includes: generating the routing table and the DNS mapping table according to the domain name forwarding management table, the virtual local area network configuration management table, and the multilink dialing.

Specifically, in an implementation, for example, when ECU1 requires a factory service (a first network service) and an Internet service (a second network service), a dialing channel datacall=3 is determined to be selected according to the dialing address management table of Table 1 above.

At this time, when ECU1 deployed in network segment 11 accesses the factory service, a corresponding dialing ID is found through Table 1 and Table 3, for example, a dialing channel datacall=4 is found based on the above tables.

When ECU1 accesses the Internet service, according to Table 1 and Table 2, dialing ID=3 is determined to be used to access the Internet service.

ECU1 uses the dialing channel datacall=4 to access the factory service, and uses the dialing channel datacall=3 to access the Internet service, thereby achieving separate dialing channels and separate network billing for the Internet service and the factory service.

In some implementations, step S103 further includes: determining, according to the DNS address acquired from the multilink dialing, in the domain name forwarding management table, the dialing channel corresponding to the target domain name; querying correctness of the target domain name, and acquiring the IP address corresponding to the target domain name; and establishing a correspondence between the DNS address and the IP address corresponding to the target domain name, and storing the correspondence in a DNS service cache.

In other implementations, after step S103, the method further includes: during a system network access process, acquiring a first domain name requested to be accessed by a target device; searching in the DNS service cache for whether a matching dialing channel exists according to the first domain name.

If exists, acquiring a first dialing channel with a pre-established matching relationship, and performing dial-up network access through the first dialing channel.

If not exists, resolving the DNS address according to a default dialing channel to obtain a second dialing channel having an associated relationship with the first domain name, and performing dial-up network access through the second dialing channel.

The method provided in this embodiment is described in detail below.

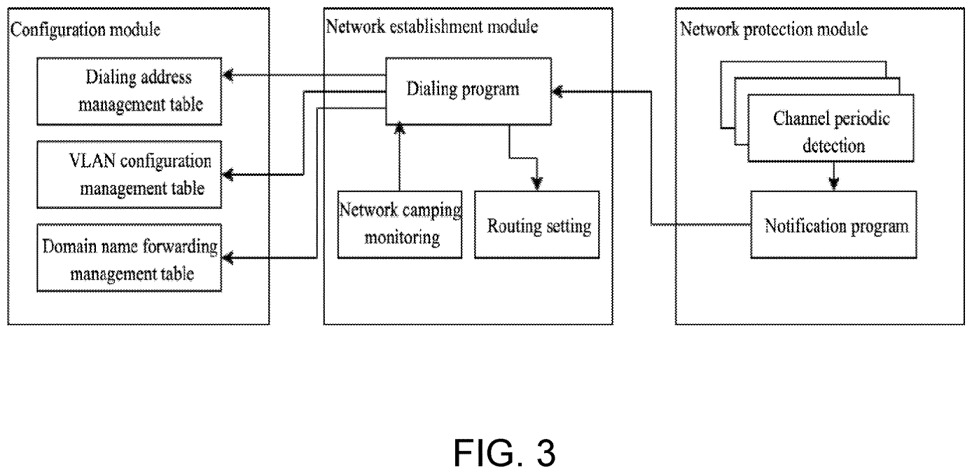

Referring to FIG. 3, a structural block diagram of an in-vehicle networking system provided by an embodiment is shown. The structural block diagram includes three parts, namely: a configuration module, a network establishment module, and a network protection module.

Specifically, the configuration module is configured to configure the aforementioned three management tables, namely the dialing address management table, the VLAN configuration management table, and the domain name forwarding management table. For the contents of these three tables, reference may be made to the description of the previous embodiments, which will not be repeated here in this embodiment.

In addition, the network establishment module includes three parts: a dialing program, a network camping monitoring program, and a routing setting program.

The network camping monitoring program is used to monitor and store a network state of the external environment through a modem, where the network state includes: no signal state (none), signal limited state (limited), and full signal state (full) dialing. The dialing in this embodiment refers to performing dial-up in the full state. When the network camping monitoring module monitors that an external network state is not connected, it will actively notify the dialing program to perform full redialing. The dialing program is responsible for completing multilink dialing according to the dialing address management table (such as Table 1 above) in a case that network camping is unobstructed. The routing setting is responsible for completing network route settings in the routing setting program according to the contents of the VLAN configuration management table (such as Table 3) and the domain name forwarding management table (such as Table 2).

The network protection module has two functions, namely: channel periodic detection and notification program. The channel periodic detection is used for a channel check program to periodically check a connection status of each data channel by means of pinging DNS according to the number of data dialing channels. When detecting that a channel is disconnected, a message is sent to notify the dialing program of the network establishment module to redial and connect the disconnected channel, so as to ensure network connectivity.

The method provided by this embodiment can complete the network supply strategy arrangement for various controllers of the vehicle according to the dialing address management table, the VLAN configuration management table, and the domain name forwarding management table, and supports services such as multilink dialing, multilink VLAN, and multi-device network supply, and data distribution according to the target domain name.

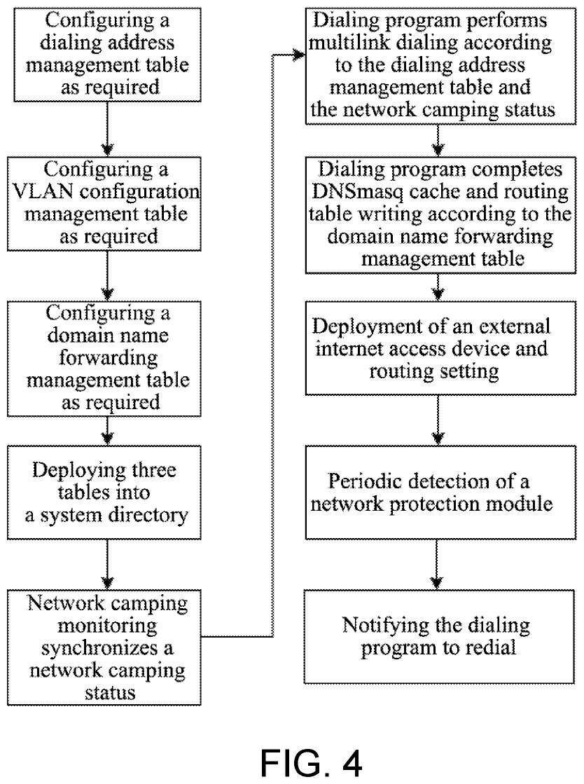

In an embodiment, referring to FIG. 4, a schematic flowchart of a configurable in-vehicle network supply method provided by an embodiment is shown. The method includes the following steps.

Step 1: configuring a dialing address management table as required. To be compatible with different operators, multiple sets of dialing addresses need to be filled in, along with corresponding accounts, passwords, and default routes.

For example, two operators namely China Unicom and China Mobile provide four dialing channels, corresponding to an enterprise private network, an enterprise public network 1, an entertainment public network 2, and a factory dedicated network, and a data dialing channel 1 with datacall=1 is defaulted inside a device.
Enterprise private network: privateAPN-apnName=cq01.5gsc.cdiot; datacall=1;
Enterprise public network 1: internetAPN-apnName=cq02.5gsc.cdiot; datacall=2;
Entertainment public network 2: proprietaryAPN-apnName=cq03.5gsc.cdiot; datacall=3;
Factory dedicated network: factoryAPN-apnName=factory.5gsc.cdiot; datacall=4.
privateAPN-apnName-cmb=CMIOT; datacall=1;
internetAPN-apnName-cmb=CMMTM2GHZXNY.SH; datacall=2;
proprietary APN-apnName-cmb=CMMTM3GHZXNY; datacall=3;
factory APN-apnName=factory.CMIOT; datacall=4.
internetAPN-apnAccount=; datacall=2;
internetAPN-apnPassword=; datacall=2;
default router=1.

Step 2: configuring a VLAN configuration management table as required.

In a process of configuring the VLAN configuration management table as required, the number of pieces of VLAN configuration information configured for an in-vehicle communication module depends on the number of connected VLANs. As shown in the table below, four VLANs are configured, corresponding to VLAN6, VLAN11, VLAN12 and VLAN13. A data dialing channel datacall=−1 corresponds to VLAN6 and VLAN13, indicating a pure local area network; a data dialing channel datacall=2 corresponds to VLAN11, indicating that VLAN11 is provided with network supply by default through the data channel datacall=2; a data dialing channel datacall=3 corresponds to VLAN12, indicating that VLAN12 is provided with network supply by default through the data channel datacall=3.
6,eth0,bridge6, 172.29.6.0/24, 172.29.6.54,AB:AB:AB:23:03:04,−1;
11,eth0,bridge11, 172.29.11.0/24,172.29.11.54,AB:AB:AB:23:03:04,2;
12,eth0,bridge12, 172.29.12.0/24, 172.29.12.54,AB:AB:AB:23:03:04,3;
13,eth0,bridge13,172.29.13.0/24, 172.29.13.54,AB:AB:AB:23:03:04,−1.

Step 3: configuring a domain name forwarding management table as required.

The domain name forwarding management table (Table 2) is configured as required. For service domain names that do not use default data dialing channels are configured independently to facilitate separate traffic billing. A configuration method is as follows.

Services with target domain names uds.******.com, tusys.******.com, vcmq.******.com, and huapp.******.com use data dialing channel 1;

Service with target domain name factory uses data channel 4, and others use a default data dialing channel corresponding to respective VLAN (VLAN11 uses 2, VLAN12 uses 3);
eth0,bridge11,1,uds.******.com,tusys.******.com,vcmq.******.com,huapp.******.com;
eth0,bridge11,4,factory.******.com.

When designing a smart factory server service, a unified domain name is factory.******.com. Through the domain name forwarding the management table, after completing route configuration, a vehicle end may forcibly forward a service with a factory domain name factory.com to dialing data channel 4, thereby ensuring the independence of channels. The operator can independently perform operations such as base station deployment, and acceleration on the channel, thereby ensuring high bandwidth and high reliability without entering a user core network, and saving traffic charges.

Step 4: deploying the above three tables to a designated directory of the configurable in-vehicle network supply system for backup. This step corresponds to step S101 of the previous embodiment.

Step 5: starting network camping monitoring, and synchronizing a network camping state.

Before acquiring a SIM card number, the method further includes: acquiring a state of a SIM card, and checking whether a SIM card state is normal; if the state is confirmed to be normal, performing the step of acquiring the SIM card number.

Specifically, when the system is running, the modem automatically completes network camping according to the SIM card state and the external network environment. The network camping-monitoring module updates the network camping state in real time for use by the dialing program module.

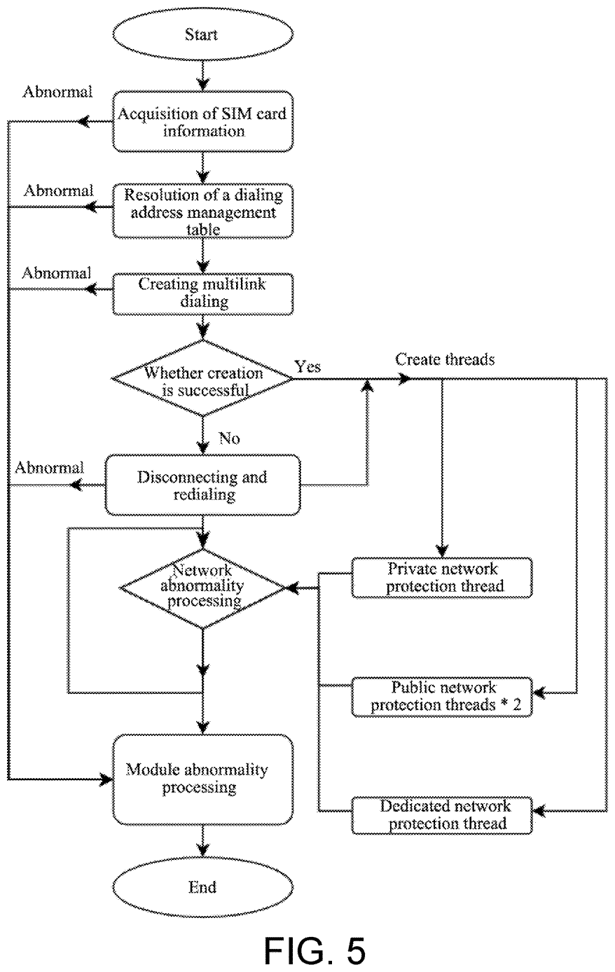

As shown in FIG. 5, when the dialing program is running, the SIM card state is first checked. When confirming that the card state is normal, its ICC ID is acquired according to an interface, which operator it belongs to is determined based on first 6 digits of the ICC ID. Then the dialing address management table (Table 1) is acquired from the system designated directory, a dialing address configured by the operator corresponding to the ICC ID is found. An existing data channel cache is cleared first, then 4-link dialing is performed respectively. After dialing, four public network IPs (gateways) and a DNS address fed back by the operator are acquired and then bound to a local egress network card, and the setting of an internal access egress is completed.

ICCID refers to an integrated circuit card identification number (smart card number), i.e., a SIM card number/serial number, including 20 characters (19 digits and the last 1 letter), which is equivalent to an ID number of a mobile phone number, including important information such as a belonging operator and a place of ownership.

DNS address refers to an IP address in a domain name system (DNS). DNS is a distributed naming system used for mapping a domain name (e.g., example.com) to a corresponding IP address (e.g., 192.0.2.1). When a user enters a domain name in a browser, a computer needs to resolve the domain name to its corresponding IP address, so as to establish a connection with a server of that domain name.

Specifically, SIM card information is acquired, resolution is performed in different dialing address management tables according to the SIM card information, multilink dialing is created. Whether each dial-up link of the created multilink dialing is successfully created is determined. If yes, i.e., successfully created, a thread is created to execute a private network protection thread flow, where the number of started private network protection threads may be one or more. In addition, a dedicated network protection thread may also be included.

If the creation is not successful, a connection is disconnected, and redialing is performed. During the redialing process, it is also determined whether the network is abnormal. If an abnormality occurs, the abnormality is processed by a module, and the flow ends after processing.

During the above detection process, if an abnormality occurs in an intermediate link, an abnormality processing module is transferred to process and resolve the above abnormality.

The above process also includes the following steps.

Step 6: the dialing program performs multilink dialing according to the dialing address management table and the network camping state.

This method corresponds to step S102 of the previous embodiment. Specifically, according to the DNS address acquired from the previous dialing, through the corresponding data channel, nslookup operation (querying the correctness of domain name resolution) is performed for each domain name, a corresponding IP address is obtained, and a corresponding relationship is stored in a DNSmasq service cache, such as:
uds.******.com 10.66.11.110;
tusys.******.com 10.66.11.111;
vcmq.******.com 10.66.11.112;
huapp.******.com 10.66.11.113.

DNSmasq is a small and convenient tool for configuring DNS and DHCP, suitable for small networks. It provides a DNS function and an optional DHCP (Dynamic Host Configuration Protocol) function. A DHCP server and a DNS server are combined, an addresses allocated by the DHCP is allowed to be normally resolved in the DNS, and these DHCP-allocated addresses and related commands may be configured into each host, or into a core device (such as a router). A service cache of DNSmasq is used to store the above correspondence between the domain name and the IP address.

Step 7: The dialing program completes DNSmasq and routing table writing operations according to the domain name forwarding management table. This step corresponds to step S103 of the previous embodiment.

Specifically, the dialing program adds the above IP to the routing table, and indicates a public network IP egress (bound to a data channel) corresponding to each IP. In the subsequent system network access process, if a device accesses the above domain names, priority will be given to query whether the above correspondence is stored in the DNSmasq service cache. If pre-stored is available, network access is implemented through a previously bound data channel. If not found, DNS resolution is performed via a default data dialing channel, and connection is established to the IP returned by the DNS.

The dialing program acquires the VLAN configuration management table (Table 3), configures a data channel for VLAN network supply according to contents, and incorporates the same into the local routing table.

For example, 11,eth0,bridge11,172.29.11.0/24,172.29.11.54,AB: AB: AB: 23:03:04,2 means providing a network supply service through a default data channel 2 for devices within VLAN11 (172.29.11.0/24,172.29.11.54) network segment.

Similarly, 12,eth1,bridge12,172.29.12.0/24, 172.29.12.54, AB: AB: AB: 23:03:04,3 means providing a network supply service through a default data channel 3 for devices within VLAN12 (172.29.12.0/24,172.29.12.54) network segment.

Step 8: deployment of an external network access device and routing setting.

In this step, the external network access device is deployed in a physical network unified with an in-vehicle communication module, an IP of the network access device is set to 172.29.11.xx, or 172.29.12.xx. For example, a DNS address is set, and a gateway address is an IP address of an in-vehicle mobile module in this network segment, such as 172.29.11.xx and 172.29.12.xx, so that network access can be performed by means of a data dialing channel 2 and a data dialing channel 3 of the in-vehicle communication module.

Step 9: periodic detection task of a network protection module.

The network protection module confirms, according to the dialing address management table, data channel contents (four data dialing channels) that need to be periodically detected, and starts to periodically detect a connection status of the four data channels by means of a ping DNS operation according to a DNS acquired by a successful initial dial-up (or a preset default DNS). As shown in FIG. 4, if it is detected that a certain data channel is disconnected, a message is sent to the dialing program through the notification program, and the content of the message includes an ID of the disconnected data channel.

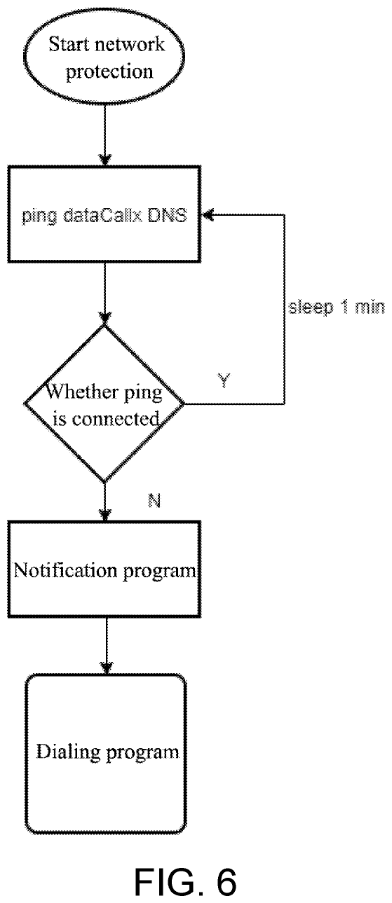

Specifically, as shown in FIG. 6, a ping connectivity detection method is provided, and the method includes: starting the network protection program, and confirming at least one dialing channel requiring periodic detection according to the dialing address management table; performing ping connectivity detection on the at least one dialing channel to determine whether each dialing channel is unobstructed; acquiring and recording a detection result, and notifying the detection result to a dialing system process.

Further, the method includes: starting network protection detection, acquiring a DNS address of ping data communication, determining whether a current ping is connected according to ping data information, and if not, starting the notification program to send a notification to the dialing program, so that the dialing program processes a detection result that the ping is not connected.

If yes, i.e., the ping is connected, next detection may be periodically performed, for example, detection is performed at an interval of 1 minute (min), to determine whether the ping is connected.

In this embodiment, the ping connectivity detection is taken as an example. In practice, other detection methods may also be included, which is not limited in this embodiment.

Finally, step 10: notifying the dialing program to redial.

Specifically, when receiving the message from the network protection module, the dialing program performs redialing operation on a data dialing channel according to a sent data dialing channel ID; when receiving a state update of a network from disconnected to connected by the network camping monitoring program, the dialing program performs redialing operation on all channels. The redialing procedure refers to the above steps 6 to 8, which will not be repeated in this embodiment.

Furthermore, the method includes: when the dialing program receives the state change of network detection from disconnected to connected by the network camping monitoring program, redialing to perform multilink dialing according to the dialing address management table and the network camping state, and updating the routing table and the DNS mapping table.

In the above step 9, acquiring and recording the detection result, and notifying the detection result to the dialing system process includes: notifying the dialing system process of a detection result that a dialing channel is disconnected, where the detection result includes a dialing channel ID of a disconnected dialing channel, and the detection result is used to indicate disconnecting a connection of the dialing channel ID.

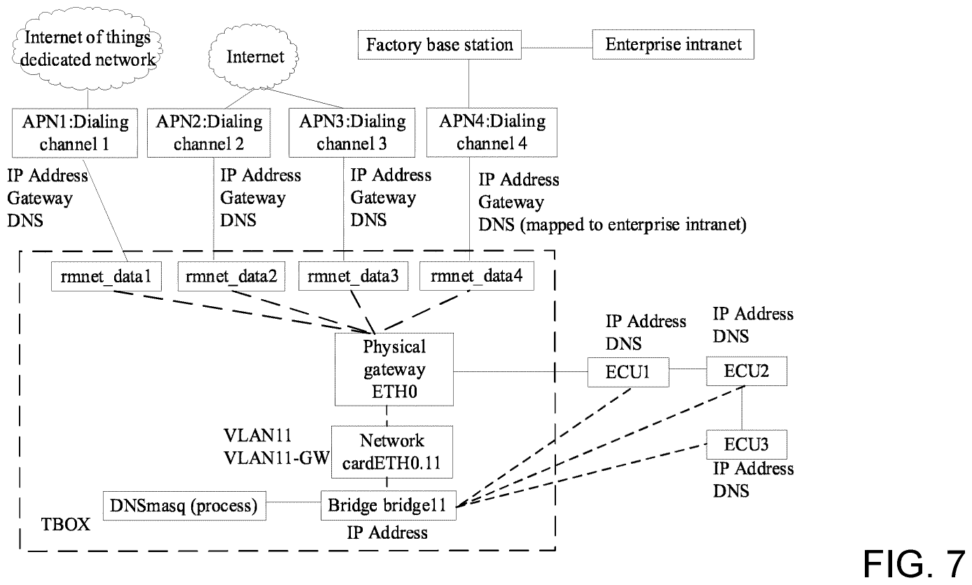

FIG. 7 shows a TBOX routing table and a DNS mapping table generated by the above embodiments.

At least one service server, such as an Internet of things dedicated network, is connected to a bridge (bridge11) through an APN1: Data Call 1, via rmnet_data1 and a physical gateway ETH0, TBOX=ETH0.11, and a corresponding IP address is: 172.29.11.54. ECU1, ECU2, and ECU3 are connected through the bridge 11.

Each ECU corresponds to a different IP address and a DNS address. A dialing channel corresponding to each apn1-apn4_DNS route may be found according to the TBOX routing table. Furthermore, rmnet is a proprietary USB virtual Ethernet framework developed for its mobile platform, and provides higher throughput through a thin layer protocol (TLP) and allows quality of service flow traffic control. In this embodiment, rmnet is used, and a data call is initiated by a QMI command sent through a QMI tool. rmnet_data1−rmnet_data4 are transmission data of the USB virtual Ethernet framework.

It can be seen from FIG. 7 that dialing channel 1 uses the Internet of things dedicated network, dialing channels 2 and 3 use Internet billing, and dialing channel 4 uses a factory base station, for example, connecting to an enterprise intranet, etc., since a DNS address of dialing channel 4 (10.100.60.114) is mapped to a host on the enterprise intranet.

The method provided in this embodiment allows vehicle manufacturers to be compatible with different operators according to requirements, configure multiple network access channels and Ethernet network supply strategies, and separate different network access channels according to device network access services, thereby ensuring the independence and chargeability of each data dialing channel, avoiding mutual influence, and simultaneously adding the network protection strategy to ensure network reliability.

In an embodiment, a configurable in-vehicle network supply apparatus is further provided, which is used to implement the above embodiments and preferred implementations, and details already described will not be repeated. As used below, the term “module” may be a combination of software and/or hardware that implements a predetermined function. Although the apparatus described in the following embodiments is preferably implemented by software, implementations by hardware or a combination of software and hardware, are also possible and contemplated.

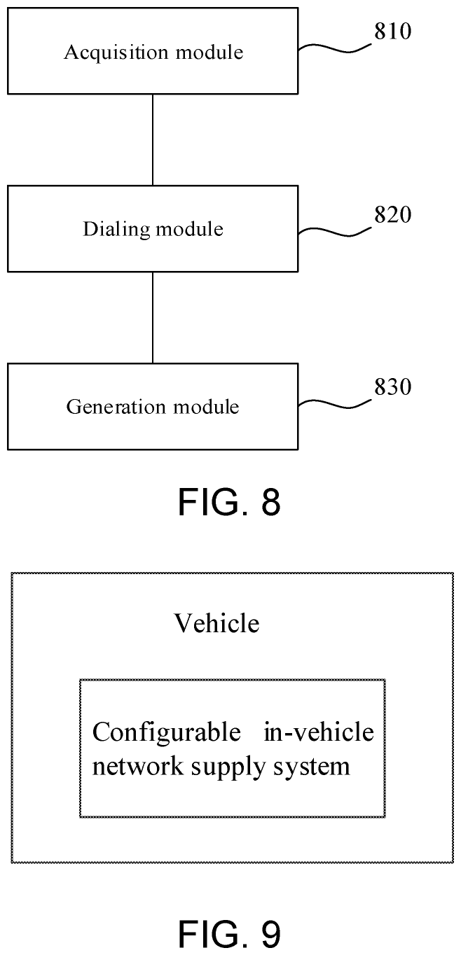

This embodiment provides a configurable in-vehicle network supply apparatus, as shown in FIG. 8, the apparatus includes: an acquisition module 810, a dialing module 820, and a generation module 830. Furthermore, the apparatus may also include other more or fewer modules, such as a sending module, a storage module, etc., which is not limited in this embodiment.

The acquisition module 810 is configured to acquire multiple pre-configured management tables and a network camping state, where the multiple management tables include: a dialing address management table and a domain name forwarding management table.

The dialing address management table is used to configure addresses, user names, and default dialing channels of multilink dialing corresponding to each operator in an in-vehicle network supply system, and the domain name forwarding management table is used to configure a relationship between each service target domain name using a non-default channel and a dialing channel.

The dialing module 820 is configured to start a dialing program, and perform multilink dialing according to the dialing address management table and the network camping state.

The generation module 830 is configured to generate a routing table and a domain name system DNS mapping table according to the domain name forwarding management table and the multilink dialing.

The DNS mapping table includes a mapping relationship between a target domain name and an IP address, and the routing table includes a correspondence between the target domain name and the dialing channel.

In an implementation, the multiple management tables further include: a virtual local area network configuration management table, and the VLAN configuration management table is used to configure a relationship between an Ethernet and the dialing channel.

The acquisition module 810 is further configured to acquire the VLAN configuration management table.

The generation module 830 is specifically configured to generate the routing table and the DNS mapping table according to the domain name forwarding management table, the virtual local area network configuration management table, and the multilink dialing.

In another implementation, the acquisition module 810 is further configured to acquire a SIM card number; the generation module 830 is further configured to determine an operator name to which a current SIM card belongs according to the SIM card number; search for a matching dialing address in the dialing address management table according to the operator name, and clear an existing data channel cache; perform the multilink dialing according to a found dialing address.

In yet another implementation, the acquisition module 810 is further configured to, after performing the multilink dialing according to the found dialing address, acquire at least one public network IP address and a DNS address fed back by different operators after the multilink dialing; bind the at least one public network IP address and the DNS address with a local egress network card to obtain a correspondence among the local egress network card, the public network IP address, and the DNS address.

In yet another implementation, the apparatus further comprises a detection module, and the detection module is connected to the acquisition module. The acquisition module 810 is further configured to acquire a state of the SIM card before acquiring the SIM card number.

The detection module is configured to check whether a SIM card state is normal; if the state is confirmed to be normal, perform the step of acquiring the SIM card number.

In yet another implementation, the generation module 830 is specifically further configured to determine, according to the DNS address acquired from the multilink dialing, in the domain name forwarding management table, the dialing channel corresponding to the target domain name; query correctness of the target domain name, and acquire the IP address corresponding to the target domain name; establish a correspondence between the DNS address and the IP address corresponding to the target domain name, and store the correspondence in a DNS service cache.

In yet another implementation, the acquisition module 810 is specifically configured to acquire, during a system network access process, a first domain name requested to be accessed by a target device; the generation module 830 is specifically configured to search in the DNS service cache for whether a matching dialing channel exists according to the first domain name;

The dialing module 820 is specifically configured to, if exists, acquire a first dialing channel with a pre-established matching relationship, and perform dial-up network access through the first dialing channel; and, if not exists, resolve a DNS address according to a default dialing channel to obtain a second dialing channel having an association relationship with the first domain name, and perform dial-up network access through the second dialing channel.

In yet another implementation, the detection module is further configured to start a network protection program, and confirm at least one dialing channel requiring periodic detection according to the dialing address management table; perform ping connectivity detection on the at least one dialing channel to determine whether each dialing channel is unobstructed; a detection result is acquired and recorded through the acquisition module 810, and the detection result is notified to a dialing system process.

In yet another implementation, the apparatus further includes a sending module, configured to notify the dialing system process of a detection result that a dialing channel is disconnected, where the detection result includes a dialing channel ID of a disconnected dialing channel, and the detection result is used to indicate disconnecting a connection of the dialing channel ID.

Furthermore, the apparatus may further include an update module, configured to, when the dialing program receives a state change of a network detection monitored from disconnected to connected by a network camping monitoring program, redial to perform the multilink dialing according to the dialing address management table and the network camping state, and update the routing table and the DNS mapping table.

It should be noted that the configurable in-vehicle network supply apparatus in this embodiment is presented in the form of functional units, where a unit refers to an ASIC circuit, a processor executing one or more software or fixed programs and a memory, and/or other devices that can provide the above functions.

Further functional descriptions of the above modules and units are the same as those of the corresponding embodiments above, and will not be repeated here.

The configurable in-vehicle network supply apparatus provided by the present application can complete the network supply strategy arrangement of various controllers of the whole vehicle, support services such as multilink dialing, multilink VLAN, and multi-device network supply, and data distribution according to the target domain name.

Furthermore, the apparatus allows vehicle manufacturers to be compatible with different operators according to requirements, configure multilink network access and Ethernet network supply strategies, and separate different network access channels according to device network access services, thereby ensuring the independence and chargeability of each data channel, avoiding mutual influence, and simultaneously adding the network protection strategy to ensure network reliability.

Furthermore, this embodiment further provides a configurable in-vehicle network supply system, a structure of the system may be as shown in the architecture of FIG. 1. Specifically, the system includes: at least one electronic control unit (ECU), a communication module, and at least one service server, where the at least one ECU is connected to the at least one service server via the communication module.

Each ECU is configured to perform the configurable in-vehicle network supply method described in the aforementioned FIG. 2, FIG. 4 to FIG. 6.

The communication module is configured to communicate with the at least one service server according to an instruction sent by the ECU; for example, searching for a corresponding dialing channel according to a dial-up instruction of the ECU, and connecting to the service server through a pre-configured dialing channel.

Each service server is configured to provide a dial-up network access service for the ECU. The service server includes but is not limited to an Internet of Things private network, the Internet, a factory dedicated network, etc.

More specifically, the functions of each component in the system and the method flow executed can be referred to the description of the previous embodiments, which will not be repeated in this embodiment.

Additionally, in an embodiment, a vehicle is further provided. As shown in FIG. 9, the vehicle includes the configurable in-vehicle network supply system shown in FIG. 1, and is configured to implement the functions of the aforementioned in-vehicle network supply system.

An embodiment of the present application further provides an electronic device having the in-vehicle network supply apparatus shown in FIG. 8 above.

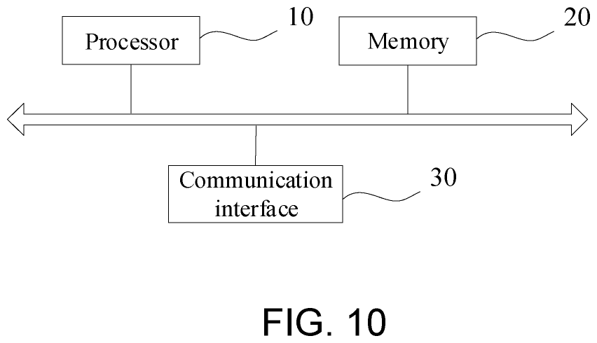

Referring to FIG. 10, FIG. 10 is a schematic structural diagram of an electronic device provided by an embodiment of the present application. As shown in FIG. 10, the electronic device includes: one or more processors 10, a memory 20, and interfaces for connecting various components, including high-speed interfaces and low-speed interfaces. The various components are communicatively connected to each other using different buses, and may be installed on a common motherboard or in other ways as needed. The processor may process instructions executed within the electronic device, including instructions stored in the memory or on the memory to display graphical information of a GUI on an external input/output apparatus (such as a display device coupled to an interface).

In some implementations, if needed, multiple processors and/or multiple buses may be used together with multiple memories. Similarly, multiple electronic devices may be connected, and each device provides some necessary operations (e.g., as a server array, a group of blade servers, or a multi-processor system). FIG. 10 takes one processor 10 as an example.

The processor 10 may be a central processing unit, a network processor, or a combination thereof. The processor 10 may further include a hardware chip. The hardware chip may be an application-specific integrated circuit, a programmable logic device, or a combination thereof. The programmable logic device may be a complex programmable logic device, a field-programmable gate array, a generic array logic, or any combination thereof.

The memory 20 stores instructions executable by the at least one processor 10 to cause the at least one processor 10 to execute the method illustrated in the above embodiments.

The memory 20 may include a program storage area and a data storage area, where the program storage area may store an operating system, an application program required for at least one function; the data storage area may store data created according to the use of the electronic device for displaying a landing page of a mini-program, etc. Furthermore, the memory 20 may include a high-speed random access memory, and may also include a non-transitory memory, such as at least one magnetic disk storage device, a flash memory device, or other non-transitory solid-state storage devices. In some implementations, the memory 20 may include memories remotely arranged relative to the processor 10, and these remote memories may be connected to the electronic device via a network. Examples of the network include, but are not limited to, the Internet, an enterprise intranet, a local area network, a mobile communication network, and combinations thereof.

The memory 20 may include a volatile memory, such as a random access memory. The memory may also include a non-volatile memory, such as a flash memory, a hard disk, or a solid-state drive. The memory 20 may also include a combination of the above types of memories.

The electronic device also includes an input/output apparatus. The processor 10, the memory 20, the input apparatus, and the output apparatus may be connected via a bus or in other ways.

The input apparatus may receive input digital or character information, and generate key signal inputs related to user settings and function control of the electronic device, such as a touch screen, a keypad, a mouse, a trackpad, a touchpad, a pointing stick, one or more mouse buttons, a trackball, a joystick, etc. The output apparatus may include a display device, an auxiliary lighting device (e.g., an LED), and a haptic feedback device (e.g., a vibration motor), etc. The display device includes, but is not limited to, a liquid crystal display, a light emitting diode, a display, and a plasma display. In some implementations, the display device may be a touch screen.

The electronic device further includes a communication interface 30 for the electronic device to communicate with other devices or communication networks, such as connecting to a TBOX, etc.

In an implementation, the electronic device may be an ECU, or a TBOX, or may also be a network device of a cloud server, such as a cloud server or a cloud server cluster, etc.

An embodiment of the present application further provides a computer-readable storage medium. The method according to the embodiments of the present application may be implemented in hardware, firmware, or as computer codes recordable on a storage medium, or as computer codes originally stored in a remote storage medium or a non-transitory machine-readable storage medium through network downloaded and to be stored in a local storage medium, so that the method described herein may be processed by such software stored on a storage medium using a general-purpose computer, a special-purpose processor, or programmable or special-purpose hardware. The storage medium may be a magnetic disk, an optical disk, a read-only memory, a random access memory, a flash memory, a hard disk, or a solid-state drive, etc. Further, the storage medium may also include a combination of the above types of memories. It can be understood that a computer, a processor, a microprocessor controller, or programmable hardware includes a storage component that can store or receive software or computer codes, and when the software or computer codes are accessed and executed by the computer, the processor, or the hardware, the method illustrated in the above embodiments is implemented.

An embodiment of the present application further provides a program product including: a computer program, and when the program product is run on a computer, the computer is caused to execute the configurable in-vehicle network supply method in any of the above implementations.

An embodiment of the present application further provides a computer program, and when the computer program is executed by a processor, the configurable in-vehicle network supply method of any of the above implementations is executed.

Although the embodiments of the present application have been described with reference to the accompanying drawings, those skilled in the art may make various modifications and variations without departing from the spirit and scope of the present application, and such modifications and variations fall within the scope defined by the appended claims.

1. A configurable in-vehicle network supply method, comprising:
acquiring multiple pre-configured management tables and a network camping state, wherein the multiple management tables comprise: a dialing address management table and a domain name forwarding management table, the dialing address management table is used to configure addresses, user names, and default dialing channels of multilink dialing corresponding to each operator in an in-vehicle network supply system, and the domain name forwarding management table is used to configure a relationship between each service target domain name using a non-default channel and a dialing channel;
starting a dialing program, and performing multilink dialing according to the dialing address management table and the network camping state;
generating a routing table and a domain name system (DNS) mapping table according to the domain name forwarding management table and the multilink dialing, wherein the DNS mapping table comprises a mapping relationship between a target domain name and an internet protocol (IP) address, and the routing table comprises a correspondence between the target domain name and the dialing channel.

2. The configurable in-vehicle network supply method according to claim 1, wherein the multiple management tables further comprise a virtual local area network configuration management table, and the virtual local area network configuration management table is used to configure a relationship between an Ethernet and the dialing channel;
wherein generating the routing table and the DNS mapping table according to the domain name forwarding management table and the multilink dialing comprises:
generating the routing table and the DNS mapping table according to the domain name forwarding management table, the virtual local area network configuration management table, and the multilink dialing.

3. The configurable in-vehicle network supply method according to claim 1, wherein performing the multilink dialing according to the dialing address management table and the network camping state comprises:
acquiring a subscriber identity module (SIM) card number, and determining an operator name to which a current SIM card belongs according to the SIM card number;
searching for a matching dialing address in the dialing address management table according to the operator name, and clearing an existing data channel cache;
performing the multilink dialing according to a found dialing address.

4. The configurable in-vehicle network supply method according to claim 3, wherein after performing the multilink dialing according to the found dialing address, the method further comprises:
acquiring at least one public network IP address and a DNS address fed back by different operators after the multilink dialing;
binding the at least one public network IP address and the DNS address with a local egress network card to obtain a correspondence among the local egress network card, the public network IP address, and the DNS address.

5. The configurable in-vehicle network supply method according to claim 3, wherein before acquiring the SIM card number, the method further comprises:
acquiring a state of the SIM card, and checking whether a SIM card state is normal;
in a case where the state is confirmed to be normal, performing the step of acquiring the SIM card number.

6. The configurable in-vehicle network supply method according to claim 4, wherein generating the routing table according to the domain name forwarding management table and the multilink dialing comprises:
determining, according to the DNS address acquired from the multilink dialing, in the domain name forwarding management table, the dialing channel corresponding to the target domain name;
querying correctness of the target domain name, and acquiring the IP address corresponding to the target domain name;
establishing a correspondence between the DNS address and the IP address corresponding to the target domain name, and storing the correspondence in a DNS service cache.

7. The configurable in-vehicle network supply method according to claim 6, wherein after generating the routing table and the domain name system DNS mapping table, the method further comprises:
during a system network access process, acquiring a first domain name requested to be accessed by a target device;
searching in the DNS service cache for whether a matching dialing channel exists according to the first domain name;
in a case where a matching dialing channel exists in the DNS service cache, acquiring a first dialing channel with a pre-established matching relationship, and performing dial-up network access through the first dialing channel;
in a case where a matching dialing channel does not exist in the DNS service cache, resolving the DNS address according to a default dialing channel to obtain a second dialing channel having an association relationship with the first domain name, and performing dial-up network access through the second dialing channel.

8. The configurable in-vehicle network supply method according to claim 1, wherein the method further comprises:
starting a network protection program, and confirming at least one dialing channel requiring periodic detection according to the dialing address management table;
performing ping connectivity detection on the at least one dialing channel to determine whether each dialing channel is unobstructed;
acquiring and recording a detection result, and notifying the detection result to a dialing system process.

9. The configurable in-vehicle network supply method according to claim 8, wherein acquiring and recording the detection result, and notifying the detection result to the dialing system process comprises:
notifying the dialing system process of a detection result that a dialing channel is disconnected, wherein the detection result comprises a dialing channel ID of a disconnected dialing channel, and the detection result is used to indicate disconnecting a connection of the dialing channel ID.

10. The configurable in-vehicle network supply method according to claim 9, wherein the method further comprises:
when the dialing program receives a state change of a network detection from disconnected to connected by a network camping monitoring program, redialing to perform the multilink dialing according to the dialing address management table and the network camping state, and updating the routing table and the DNS mapping table.

11. A configurable in-vehicle network supply apparatus, comprising: a memory and a processor, wherein the memory is connected to the processor; the memory stores computer instructions, and the processor executes the computer instructions to cause the processor to:
acquire multiple pre-configured management tables and a network camping state, wherein the multiple management tables comprise: a dialing address management table and a domain name forwarding management table, the dialing address management table is used to configure addresses, user names, and default dialing channels of multilink dialing corresponding to each operator in an in-vehicle network supply system, and the domain name forwarding management table is used to configure a relationship between each service target domain name using a non-default channel and a dialing channel;
start a dialing program, and perform multilink dialing according to the dialing address management table and the network camping state;
generate a routing table and a domain name system (DNS) mapping table according to the domain name forwarding management table and the multilink dialing, wherein the DNS mapping table comprises a mapping relationship between a target domain name and an internet protocol (IP) address, and the routing table comprises a correspondence between the target domain name and the dialing channel.

12. The configurable in-vehicle network supply apparatus according to claim 11, wherein the multiple management tables further comprise a virtual local area network configuration management table, and the virtual local area network configuration management table is used to configure a relationship between an Ethernet and the dialing channel, the processor executes the computer instructions to further cause the processor to:
generate the routing table and the DNS mapping table according to the domain name forwarding management table, the virtual local area network configuration management table, and the multilink dialing.

13. The configurable in-vehicle network supply apparatus according to claim 11, wherein the processor executes the computer instructions to further cause the processor to:
acquire a subscriber identity module (SIM) card number, and determine an operator name to which a current SIM card belongs according to the SIM card number;
search for a matching dialing address in the dialing address management table according to the operator name, and clear an existing data channel cache;
perform the multilink dialing according to a found dialing address.

14. The configurable in-vehicle network supply apparatus according to claim 13, wherein after performing the multilink dialing according to the found dialing address, the processor executes the computer instructions to further cause the processor to:
acquire at least one public network IP address and a DNS address fed back by different operators after the multilink dialing;
bind the at least one public network IP address and the DNS address with a local egress network card to obtain a correspondence among the local egress network card, the public network IP address, and the DNS address.

15. The configurable in-vehicle network supply apparatus according to claim 13, wherein before acquiring the SIM card number, the processor executes the computer instructions to further cause the processor to:
acquire a state of the SIM card, and check whether a SIM card state is normal;
in a case where the state is confirmed to be normal, perform the step of acquiring the SIM card number.

16. The configurable in-vehicle network supply apparatus according to claim 14, wherein the processor executes the computer instructions to further cause the processor to:
determine, according to the DNS address acquired from the multilink dialing, in the domain name forwarding management table, the dialing channel corresponding to the target domain name;
query correctness of the target domain name, and acquire the IP address corresponding to the target domain name;
establish a correspondence between the DNS address and the IP address corresponding to the target domain name, and store the correspondence in a DNS service cache.

17. The configurable in-vehicle network supply apparatus according to claim 16, wherein after generating the routing table and the domain name system DNS mapping table, the processor executes the computer instructions to further cause the processor to:
during a system network access process, acquire a first domain name requested to be accessed by a target device;
search in the DNS service cache for whether a matching dialing channel exists according to the first domain name;
in a case where a matching dialing channel exists in the DNS service cache, acquire a first dialing channel with a pre-established matching relationship, and perform dial-up network access through the first dialing channel;
in a case where a matching dialing channel does not exist in the DNS service cache, resolve the DNS address according to a default dialing channel to obtain a second dialing channel having an association relationship with the first domain name, and perform dial-up network access through the second dialing channel.

18. A configurable in-vehicle network supply system, wherein the system comprises: at least one electronic control unit (ECU), a communication module, and at least one service server, and the at least one ECU is connected to the at least one service server through the communication module;
each ECU is configured to execute the configurable in-vehicle network supply method according to claim 1;
the communication module is configured to communicate with the at least one service server according to an instruction sent by the ECU;
each service server is configured to provide a dial-up network access service for the ECU.

19. A vehicle, wherein the vehicle comprises a configurable in-vehicle network supply system according to claim 18.

20. A non-transitory computer-readable storage medium, wherein the computer-readable storage medium stores computer instructions, and the computer instructions are used to cause a computer to execute steps of:
acquiring multiple pre-configured management tables and a network camping state, wherein the multiple management tables comprise: a dialing address management table and a domain name forwarding management table, the dialing address management table is used to configure addresses, user names, and default dialing channels of multilink dialing corresponding to each operator in an in-vehicle network supply system, and the domain name forwarding management table is used to configure a relationship between each service target domain name using a non-default channel and a dialing channel;
starting a dialing program, and performing multilink dialing according to the dialing address management table and the network camping state;
generating a routing table and a domain name system (DNS) mapping table according to the domain name forwarding management table and the multilink dialing, wherein the DNS mapping table comprises a mapping relationship between a target domain name and an internet protocol (IP) address, and the routing table comprises a correspondence between the target domain name and the dialing channel.
